(19) United States
(12) Patent Application Publication
(10) Pub. No.: US 2010/0182924 A1
(43) Pub. Date: Jul. 22, 2010

(54) METHOD OF CHANGING TRANSMISSION MODE, METHOD OF REQUESTING PACKET RETRANSMISSION, AND METHOD OF RETRANSMITTING PACKET

(75) Inventors: Tae Chul Hong, Daejeon (KR); Kun Seok Kang, Daejeon (KR); Do-Seob Ahn, Daejon (KR); Ho Jin Lee, Daejeon (KR)

Correspondence Address: RABIN & Berdo, PC, 1101 14TH STREET, NW, SUITE 500, WASHINGTON, DC, 20005, US

(73) Assignee: Electronics & Telecommunications Research Inst., Yuseong-gu, Daejeon (KR)

(21) Appl. No.: 12/667,433

(22) PCT Filed: May 8, 2008
(86) PCT No.: PCT/KR2008/002603

§ 371 Date: Dec. 31, 2009

(30) Foreign Application Priority Data
Jul. 3, 2007 (KR) 10-2007-0066503

(51) Int. Cl. H04W 24/00; H04H 20/71

(52) U.S. Cl. 370/252; 370/312

(57) ABSTRACT

The present invention is directed to a method of changing a transmission mode, a method of requesting a packet retransmission, and a method of retransmitting a packet with respect to a broadcasting or multicast service. According to the invention, a plurality of terminals provided with one broadcasting or multicast service shares one random access channel (RACH) so as to transmit channel information. Accordingly, a base station receives the channel information through one RACH from the terminal or detects a packet collision generated in the RACH to confirm a request for changing the transmission mode or a request for maintaining the transmission mode by the terminal.

### TECHNICAL FIELD

The present invention relates to a method of changing a transmission mode, a method of requesting a packet retransmission, and a method of retransmitting a packet. More particularly, the present invention relates to a method of changing a transmission mode, a method of requesting a packet retransmission, and a method of retransmitting a packet with respect to a broadcasting or multicast service.

The present invention was supported by the IT R&D program of MIC/IITA [2005-S-014-03, Satellite IMT 2000+ Technology Development].

### BACKGROUND ART

In a mobile communication system such as code division multiple access 2000 (CDMA2000) 1× EV-DO for using a related art packet-switched mode, packets are transmitted to each user by multiplexing the packets every time-slot using a time division multiplexing mode in a downlink. Furthermore, a base station transmits the packets to each time-slot at maximum power, and each user terminal measures a received signal-to-interference ratio of pilot symbols to be inserted and transmitted to each time-slot. Based on the measured value of the received signal-to-interference ratio, the terminal selects a data rate that is adequate for a present status from a table of a predetermined data rate and reports it to the base station. After receiving the data rate, the base station performs the scheduling of transmission packets based on the selected data rate.

Meanwhile, in a case of a broadcasting or multicast service to be provided for many users, the data should be simultaneously transmitted to many users. Therefore, in a case of collecting channel information of individual users as described above, a number of uplink feedback channels are required. Accordingly, in the broadcasting or multicast service, when using the pilot symbols as in an existing mobile communication system, it is difficult to receive adequate data rate information from the terminal depending on channel status and to select the data rate. Furthermore, a request for retransmitting an error-packet with respect to the broadcasting or multicast service is performed individually. Therefore, since retransmission requests should be collected from many users, a number of feedback channels are required.

Particularly, in a case of being aimed at a great many users like a broadcasting or multicast service using a satellite, the channel information and the retransmission request of the individual users are not easily received. Accordingly, in this case, there is difficulty in carrying out adaptive transmission and adequate packet retransmission.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide to a method of changing a transmission mode, a method of requesting a packet retransmission, and a method of retransmitting a packet that are suitable for a broadcasting or multicast service to be provided for many users.

### Technical Solution

In order to achieve above-described object, a method of changing a transmission mode by a terminal receiving a data packet of a broadcasting or multicast service according to an exemplary embodiment of the invention includes:

taking allocation of a random access channel so as to transmit channel information corresponding to the broadcasting or multicast service; measuring a received signal quality by using a pilot signal included in the data packet; determining whether a change of transmission mode is necessary based on the received signal quality; and transmitting channel information for requesting the change of the transmission mode through the random access channel, when the change of the transmission mode is necessary.

A method of changing a transmission mode by a terminal for receiving a data packet of a broadcasting or multicast service according to another embodiment of the invention includes:

taking allocation of a random access channel so as to transmit channel information corresponding to the broadcasting or multicast service; receiving a message for changing the transmission mode; determining whether a change of transmission mode is suitable based on a received signal quality of the data packet; and transmitting a request for maintaining the transmission mode through the random access channel, when the change of the transmission mode is not suitable.

A method of changing a transmission mode by a base station for providing broadcasting or multicast service according to yet another embodiment of the invention includes:

allocating a channel to at least one terminal so as to receive a channel information packet corresponding to the broadcasting or multicast service; confirming whether a packet is transmitted through the channel from the at least one terminal; and changing a transmission mode corresponding to the broadcasting or multicast service, when the packet is transmitted through the channel.

A method of changing a transmission mode by a base station for providing a broadcasting or multicast service according to yet another embodiment of the invention includes:

requesting a change of a transmission mode, when a request for changing the transmission mode is not transmitted from at least one terminal provided with the broadcasting and multicast service during a predetermined time; maintaining a transmission mode corresponding to the broadcasting or multicast service, when a response is transmitted from the at least one terminal depending on the request for changing the transmission mode; and changing the transmission mode, when the number of requests for changing the transmission mode is not less than a predetermined number.

A method of requesting a packet retransmission by a terminal provided with a broadcasting or multicast service according to yet another embodiment of the invention includes:

taking allocation of a random access channel so as to transmit a request for the packet retransmission; confirming whether an error-packet exists in data packets received depending on the broadcasting or multicast service; and transmitting the request for the packet retransmission by using the random access channel, when it is determined that the error-packet exists.

A method of retransmitting a packet by a base station provided with a broadcasting or multicast service according to yet another embodiment of the present invention includes:

allocating a channel so as to receive a request for retransmitting the packet; retransmitting a packet corresponding to the request for retransmitting the packet, when the request for retransmitting the packet is received through the channel; and retransmitting all packets transmitted during a present feedback interval of the broadcasting or multicast service, when a packet collision is generated in the channel.

### ADVANTAGEOUS EFFECTS

In one method according to the exemplary embodiments of the invention, one channel can be shared such that the plurality of terminals provided with one broadcasting or multicast service transmit the channel information packet or the retransmission request packet. This method can efficiently use the resource as compared to the related art method of separately allocating the channel to each terminal such that the plurality of terminals transmit the channel information packet or the retransmission request packet. Accordingly, the method according to the exemplary embodiments of the invention is suitable for the mode, for example the broadcasting or multicast service that simultaneously transmits the data packet to many users.

Furthermore, even though channel information packets or retransmission request packets transmitted through one channel from the terminal collide with each other, the base station can confirm whether the transmitted packet corresponds to a request for changing the transmission mode, a request for maintaining the transmission mode, or a request for data packet retransmission.

Accordingly, the base station can change the transmission mode and retransmit the data packet depending on the request of the terminal.

### DESCRIPTION OF DRAWINGS

FIG. 1 is a diagram illustrating a mobile communication network according to a first exemplary embodiment of the present invention.

FIG. 2 is a diagram illustrating a packet representing channel information under a circumstance of requesting a downward adjustment of transmission mode according to the first exemplary embodiment of the invention.

FIG. 3 is a diagram illustrating a packet representing channel information corresponding to response to a request for an upward adjustment of transmission mode from a base station according to the first exemplary embodiment of the invention.

FIG. 4 is a diagram illustrating an example for classifying one RACH into time intervals and separately allocating a CQI-DOWN channel or CQI-UP channel corresponding to each service to each of the classified time intervals in accordance with the first exemplary embodiment of the invention.

FIG. 5 is a diagram illustrating another example for separately allocating a CQI-DOWN channel or CQI-UP channel by using independent RACH for each service in accordance with the first exemplary embodiment of the invention.

FIG. 6 is a flowchart illustrating a method of downwardly adjusting the transmission mode by the base station according to the first exemplary embodiment of the invention.

FIG. 7 is a flowchart illustrating a method of upwardly adjusting the transmission mode by the base station according to the first exemplary embodiment of the invention.

FIG. 8 is a flowchart illustrating a method of transmitting the channel information on the downward adjustment of transmission mode by a terminal according to the first exemplary embodiment of the invention.

FIG. 9 is a flowchart illustrating a method of transmitting the channel information by the terminal so as to maintain the transmission mode according to the first exemplary embodiment of the invention.

FIG. 10 is a diagram illustrating a configuration of a feedback packet according to a second exemplary embodiment of the invention.

FIG. 11 is a flowchart illustrating a method of requesting the packet retransmission by the terminal according to the second exemplary embodiment of the invention.

FIG. 12 is a flowchart illustrating a method of retransmitting a packet by the base station according to the second exemplary embodiment of the invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements through the specification.

It will be understood that when it is referred to that some parts include some constituent elements, this does not exclude the presence of other constituent elements throughout the specification, unless otherwise described in particular.

A method of transmitting channel information, a method of changing a transmission mode, a method of requesting a packet retransmission, and a method of retransmitting a packet according to the exemplary embodiments of the invention will now be described in detail with reference to the drawings.

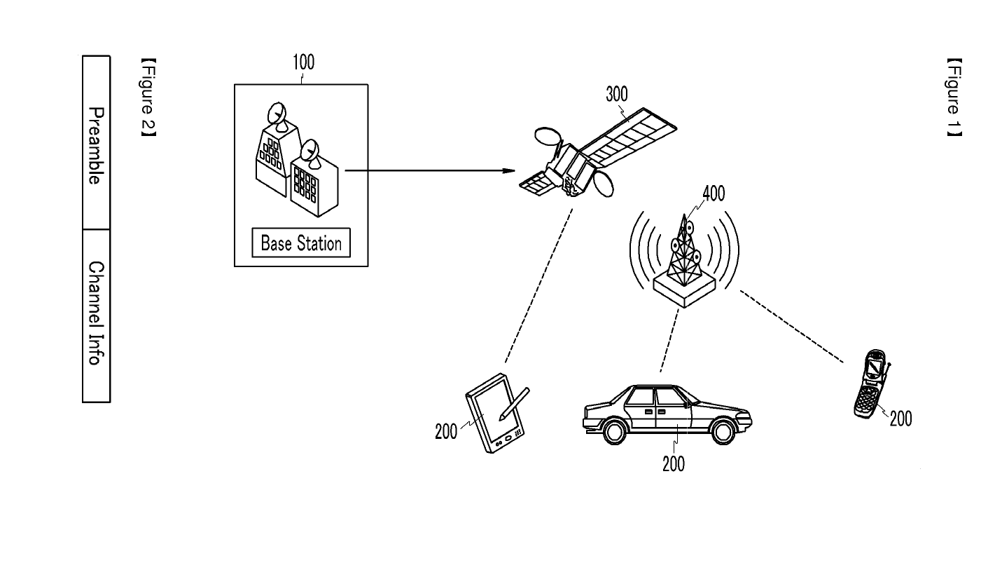

The method of transmitting the channel information and the method of changing the transmission mode according to a first exemplary embodiment of the invention will hereinafter be described in detail with reference to FIG. 1 to FIG. 9.

FIG. 1 illustrates a mobile communication network according to the first exemplary embodiment of the invention.

Here, the mobile communication network includes at least one of a land mobile communication network and a satellite mobile communication network.

Referring to FIG. 1, a base station 100 transmits data such as a motion picture, a still image, or a text type for the purpose of a broadcasting or multicast service. Meanwhile, the base station 100 adopts an adaptive transmission mode that changes the transmission mode depending on channel status so as to transmit data packets. With this view, the base station 100 allocates a random access channel (RACH) such that a terminal 200 transmits the channel information.

The terminal 200 receives packets transmitted from the base station 100 through a satellite 300 or transmitting tower 400 and provides the received packets to users. At this time, the terminal 200 may request a change of the transmission mode through the allocated RACH or may transmit a rejection to a request for changing the transmission mode by the base station 100.

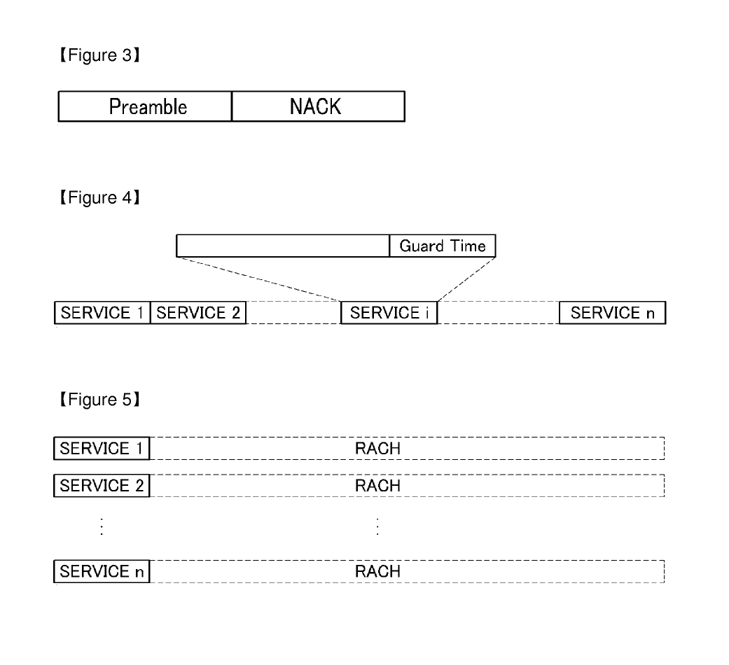

FIG. 2 and FIG. 3 illustrate packet configurations for transmitting the channel information according to the first exemplary embodiment of the invention, respectively. FIG. 2 illustrates the packet representing the channel information under a circumstance of requesting a downward adjustment of transmission mode, and FIG. 3 illustrates the packet representing channel information that corresponds to a response to an upward adjustment request of transmission mode from a base station 100.

Here, the RACH is designated as a channel quality information (CQI)-DOWN channel and a CQI-UP channel. The CQI-DOWN channel is allocated so as to transmit the packets at the time of requesting the downward adjustment of transmission mode, and the CQI-UP channel is allocated so as to transmit the packet at the time of rejecting the request for the upward adjustment of the transmission mode made by the base station 100.

Referring to FIG. 2, the channel information packet to be transmitted through the CQI-DOWN channel includes a preamble and channel information. The channel information represents the transmission mode that the terminal 200 can receive without an error. Accordingly, the length of the channel information packet varies depending on the number of adaptive transmission modes that are capable of being used in a system. For example, in a case of using eight adaptive transmission modes, the channel information can be represented by 3 bits.

Referring to FIG. 3, the channel information packet to be transmitted through the CQI-UP channel includes the preamble and response information (NACK) on the change request.

The response information on the change request is the response information of the terminal 200 when the base station 100 requests the upward adjustment of the transmission mode to the terminal 200. The terminal 200 determines whether or not the upward adjustment of transmission mode can be performed depending on the status of the channel receiving the broadcasting or multicast data packet. If the upward adjustment is difficult, the terminal 200 transmits the rejection response against the upward adjustment to the base station 100. Therefore, the response information is transmitted so as to inform of the rejection only when the terminal 200 rejects the upward adjustment of transmission mode. Furthermore, the response information can be configured as 1 bit.

Meanwhile, as illustrated in FIG. 2 and FIG. 3, the method of transmitting both the preamble and the packet together reduces a delay time compared to the mode that transmits the preambles first and transmits the packet after confirming non-collision of the preambles. In a related art mode that transmits the preambles first and transmits the packet only when the preambles do not collide with each other, there is a problem that a long round-trip delay time is consumed up to the confirmation of the collision or non-collision after the transmission of preambles.

FIG. 4 and FIG. 5 illustrate a method of allocating a CQI-DOWN channel and CQI-UP channel to a plurality of services in accordance with the first exemplary embodiment of the invention, respectively. FIG. 4 illustrates an example for classifying one RACH into time intervals and separately allocating a CQI-DOWN channel or CQI-UP channel corresponding to each service to a classified time interval, and FIG. 5 illustrates another example for separately allocating the CQI-DOWN channel or the CQI-UP channel to each service by using an independent RACH.

Referring to FIG. 4, in a case of allocating the CQI-DOWN channel or CQI-UP channel to a plurality of broadcasting or multicast services, the base station 100 divides one RACH into a number of time intervals and allocates the CQI-DOWN channel or CQI-UP channel to the broadcasting or multicast service corresponding to each time interval. Therefore, the RACH is classified into time intervals of as many as the number of broadcasting or multicast services provided by the base station 100. Here, the CQI-DOWN channel and CQI-UP channel allocated to each of the broadcasting or multicast services is shared by all terminals 200 receiving the data packet of the corresponding service.

Meanwhile, the length of one time interval is determined by a guard time, taking a time error into consideration and a packet length of channel information that is ready to be received. Here, the terminal 200 utilizes the service corresponding to the time interval, and a time error can be generated due to the distance of the terminal 200. The guard time is set to a sufficient length such that the packet reception and the packet collision generated in a previous time interval do not have an effect on the next time interval.

The mode described above is utilized to allocate the CQI-DOWN channel or CQI-UP channel to a plurality of services by dividing one RACH into the plurality of time intervals. With this configuration, the mode has an effect of being capable of receiving a number of channel information packets of the terminal 200 with a small channel capacity.

Referring to FIG. 5, in a case of allocating the CQI-DOWN channel or the CQI-UP channel to the plurality of broadcasting or multicast services, the base station 100 utilizes a separate RACH for each service. In this case, the base station 100 allocates a separate RACH to each service and receives the channel information packets by using the allocated RACH. At this time, each of the channel information packets also includes the guard time. Furthermore, the CQI-DOWN channel and CQI-UP channel allocated to each of the broadcasting or multicast services are shared by all terminals 200 receiving the data packets of the corresponding service.

Meanwhile, in this case, the time interval of dividing each RACH is set depending on a period in which the packets are transmitted from the base station 100 by taking the round-trip delay time into consideration. For example, if ten packets are transmitted from the base station 100 during the round-trip delay time, the time interval for transmitting the channel information packets should also be divided into ten during the round-trip delay time. This is to synchronize the transmission of the channel information packet with the packet transmission period.

As described above, the first exemplary embodiment of the invention includes two methods. One method is to divide one RACH into a number of time intervals and to allocate the CQI-DOWN channel or CQI-UP channel corresponding to one service to each time interval. The other method is to allocate the CQI-DOWN channel or the CQI-UP channel of the corresponding service to each RACH by allocating the RACH as well as the number of services. Although the two methods are used separately in the first exemplary embodiment of the invention, it is possible to use a combination of the two methods.

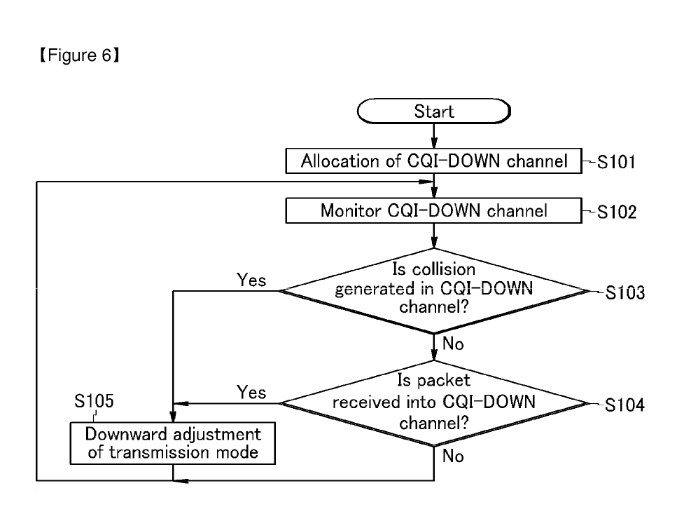

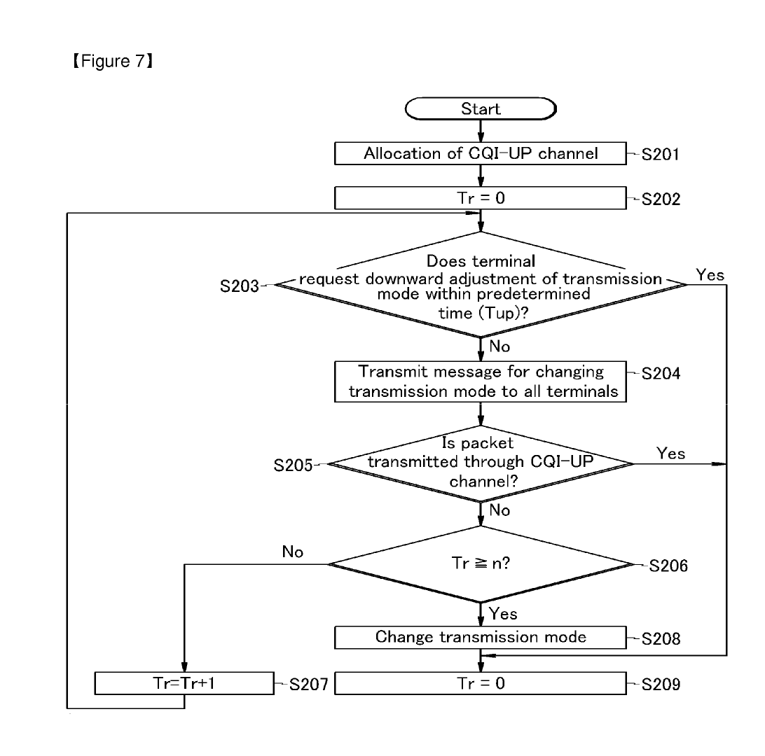

FIG. 6 and FIG. 7 are flowcharts illustrating a method of changing the transmission mode of the base station 100 according to the first exemplary embodiment of the invention, respectively. FIG. 6 illustrates the method of downwardly adjusting the transmission mode, and FIG. 7 illustrates the method of upwardly adjusting the transmission mode.

Referring to FIG. 6, the base station 100 provides the broadcasting or multicast service to a plurality of terminals 200 and allocates the CQI-DOWN channel for receiving the channel information for every broadcasting or multicast service (S101). At this time, a RACH is used as the allocated channel, and the CQI-DOWN channel corresponding to each service may be separately allocated for each service as illustrated in FIG. 4 or FIG. 5. Furthermore, each CQI-DOWN channel is shared by all terminals 200 that receive the data packet of the corresponding service.

When the CQI-DOWN channel is allocated, the base station 100 monitors each CQI-DOWN channel so as to confirm whether channel information is received from the terminal 200 (S102).

If the packets are transmitted through the CQI-DOWN channel from the terminal 200 to collide with each other (S103), and if the channel information packets are received from the CQI-DOWN channel (S104), the base station 100 determines this as a request for changing the transmission mode by the terminal 200. Furthermore, in this case, the base station 100 also adjusts the data packet transmission mode of the service corresponding to the CQI-channel (S105). At this time, the channel information received through the CQI-DOWN channel is the downward adjustment request for the transmission mode by the terminal 200. Furthermore, the terminal 200 selects a suitable transmission mode based on the received signal quality and transmits the channel information including the selected transmission mode. That is, the terminal 200 confirms the received signal quality by using a pilot symbol included in the data packet of the broadcasting or multicast service being received. When the received signal quality is low, the terminal 200 selects the suitable transmission mode and transmits the channel information packet as configured in FIG. 2 to the base station 100. The base station 100 receives the channel information packet and changes the data packet-transmission mode of the corresponding service based on the channel information packet. When the packet collision is generated in the CQI-DOWN channel, the base station 100 determines that the terminal 200 receives the request for the downward change of the transmission mode and changes the transmission mode of the corresponding service to one lower level from the present transmission mode. Here, the transmission mode represents a transmission speed (data rate), and the downward adjustment of transmission mode represents the downward adjustment of transmission speed.

Meanwhile, when no channel information packet is transmitted from the terminal 200 for the purpose of the downward adjustment of transmission mode, the base station 100 determines whether the upward adjustment of transmission mode is performed, as follows. That is, when the packet collision is generated in the CQI-DOWN channel (S103) and when the channel information packet is not received in the CQI-DOWN channel (S104), the base station 100 determines whether the upward adjustment of transmission mode is performed, as follows.

In FIG. 7, the base station 100 providing the broadcasting or multicast services to the plurality of terminals 200 allocates the CQI-UP channel to each broadcasting or multicast service (S201). Furthermore, the base station 100 allows the transmission number Tᵣ of transmission change messages to be initialized (Tᵣ=0) (S202). At this time, the RACH is used as the allocated channel, and the CQI-UP channel corresponding to each service may be separately allocated to each service as illustrated in FIG. 4 or FIG. 5. Furthermore, each CQI-UP channel is shared by all terminals 200 receiving the data packet of the service corresponding to the channel.

Then, the base station 100 confirms whether the terminal 200 transmits a transmission mode downward request (S203). When the terminal 200 does not transmit a transmission mode downward request, the base station 100 confirms a time at which the downward request for transmission mode is not transmitted from the terminal 200. That is, when the channel information packet for requesting the downward adjustment of transmission mode is not received through the CQI-DOWN channel from the terminal 200, and when no packet collision is generated in the CQI-DOWN channel, the base station 100 confirms the time at which the channel information packet is not transmitted from the terminal 200. In addition, when the channel information packet is not transmitted through the CQI-DOWN channel from the terminal 200 during a predetermined time T_{UP}, the base station 100 transmits a message for changing the transmission mode to the terminal 200. That is, when the base station 100 does not receive any packet through the CQI-DOWN channel or when the packet collision is not generated in the CQI-DOWN channel, the base station 100 transmits the message for changing the transmission mode to the terminal 200 (S204).

Then, the base station 100 monitors the CQI-UP channel to confirm whether the terminal 200 transmits the packet through the CQI-UP channel (S205). That is, the base station 100 confirms whether the packets are received through the CQI-UP channel or whether the packet collision is generated in the CQI-UP channel.

When no packet is transmitted through the CQI-UP channel from the terminal 200, the base station 100 determines that the terminal 200 approves the change of the transmission mode. That is, when the packets are not received through the CQI-UP channel or when the packet collision is not generated in the CQI-UP channel, the base station 100 determines that the terminal 200 approves the change of the transmission mode.

If the base station 100 determines that the terminal 200 approves the change of the transmission mode, the base station 100 confirms the transmission number Tᵣ of the message for changing the transmission mode. At this time, the base station 100 confirms whether the transmission number Tᵣ is not less than a predetermined maximum transmission number (n) (S206).

When the transmission number Tᵣ is less than the maximum transmission number (n), the base station 100 increases the transmission number (Tᵣ=Tᵣ+1) (S207) and then monitors the CQI-DOWN channel for whether the terminal 200 transmits the request for changing transmission mode. At this time, the message for changing the transmission mode to be transmitted from the terminal 200 includes only a flag informing the terminal 200 of the transmission mode change. Alternatively, the message for changing the transmission mode may include transmission mode information that is changed by the base station 100.

Meanwhile, if the transmission number Tᵣ is larger than or equal to the maximum transmission number (n), the base station 100 changes the transmission mode (S208) and allows the transmission number Tᵣ to be initialized (Tᵣ=0) (S209). At this time, the base station 100 performs the upward adjustment of transmission mode.

Meanwhile, when the packet is transmitted through a CQI-DOWN channel by the terminal 200 during a predetermined time T_{UP} (S203), the base station 100 initializes (Tᵣ=0) the transmission number (S209) and performs the downward adjustment of transmission mode, as illustrated in FIG. 6.

Furthermore, when the packet is transmitted through the CQI-UP channel by the terminal 200 (S205), the base station 100 determines this as a request for maintaining the transmission mode. In this case, the base station 100 does not change the transmission mode and allows the transmission number Tᵣ to be initialized (Tᵣ=0) (S209).

FIG. 8 and FIG. 9 illustrate a method of transmitting the channel information by the terminal 200 according to the first exemplary embodiment of the invention, respectively. FIG. 8 illustrates a method of transmitting the channel information on the downward adjustment of transmission mode by the terminal 200, and FIG. 9 illustrates a method of transmitting the channel information by the terminal 200 so as to maintain the transmission mode, when the base station 100 requests the upward adjustment of transmission mode.

Referring to FIG. 8, the CQI-DOWN channel is allocated to the terminal 200 so as to transmit the channel information packet depending on the data packet reception of the broadcasting or multicast service (S301).

Furthermore, the terminal 200 measures a received signal quality by using a pilot signal of the data packet to be received so as to transmit the channel information packet to the base station 100 (S302).

Then, the terminal 200 determines whether the present transmission mode is suitable based on the measurement of the received signal quality (S303). If the present transmission mode is not suitable, the terminal 200 transmits the channel information packet for requesting the change of the transmission mode to the CQI-DOWN channel (S304). At this time, the channel information packet to be transmitted includes transmission mode information that is suitable for receiving the data packet of the present service, as illustrated in FIG. 2. The suitability is determined by the terminal 200.

Referring to FIG. 9, the CQI-UP channel is allocated to the terminal 200 so as to transmit the channel information packet depending on the data packet reception of the broadcasting or multicast service (S401).

Then, when the terminal 200 receives the message for changing the transmission mode from the base station 100 while receiving the data packet of the broadcasting or multicast service (S402), the terminal 200 determines whether the change of the transmission mode by the base station 100 is suitable, based on the received signal quality measured by using the pilot signal of the data packet (S403). At this time, the terminal 200 acquires the transmission mode information to be transmitted by the base station 100 from the message for changing the transmission mode. When the message for changing the transmission mode does not include the transmission mode information to be changed, the terminal 200 recognizes this as a transmission mode to be changed. The transmission mode to be changed is one level higher than the present transmission mode.

Meanwhile, when the transmission mode to be changed is not suitable for the present channel status, the terminal 200 transmits the channel information packet for requesting the cancellation of the transmission mode change, through the CQI-UP channel (S404). At this time, the channel information packet to be transmitted is configured as illustrated in FIG. 3, and includes the response information for rejecting the change of the transmission mode.

As described above, in the mode where the plurality of terminals provided with one broadcasting or multicast service share the CQI-DOWN channel or CQI-UP channel so as to transmit the channel information packet, the plurality of terminals 200 transmit the channel information packet without separately allocating the channel to each terminal 200. Therefore, the base station 100 may efficiently acquire the channel information at the service, for example the broadcasting or multicast service that simultaneously provides the data packet to many users, thereby adaptively changing the transmission mode.

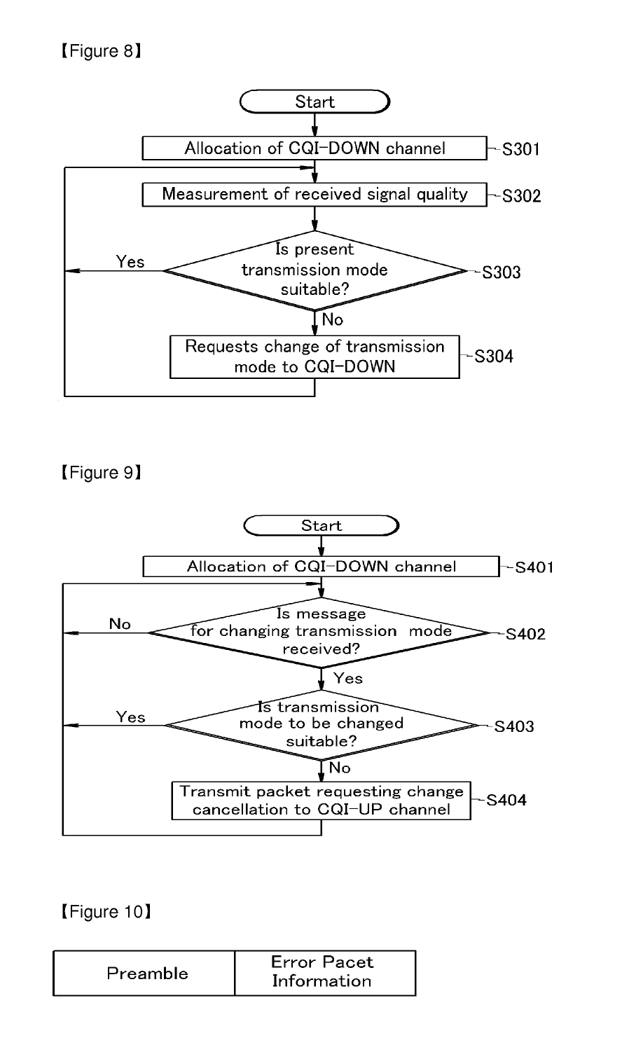

Referring to FIG. 10 to FIG. 12, a method of requesting a packet retransmission and a method of retransmitting a packet according to a second exemplary embodiment of the invention will now be described in detail.

Since a mobile communication network according to the second exemplary embodiment of the invention is the same as in FIG. 1, a detailed description thereof will be omitted. The mobile communication network includes at least one of a land mobile communication network and a satellite mobile communication network.

According to the second exemplary embodiment of the invention, when an error is generated during the transmission of the data packet corresponding to the broadcasting or multicast service, the base station 100 allocates the RACH so as to receive a retransmission request (RR) from the terminal 200. Furthermore, when the terminal 200 transmits a feedback packet through the RACH, the base station 100 retransmits the data packet based on the feedback packet.

In addition, when a transmission error is generated during the reception of the data packet corresponding to the broadcasting or multicast service, the terminal 200 transmits the feedback packet through the RACH.

FIG. 10 illustrates a configuration of a feedback packet according to the second exemplary embodiment of the invention.

Here, the RACH allocated for the transmission of the feedback packet is designated as an RR channel.

Referring to FIG. 10, the feedback packet is transmitted through the CQI-DOWN channel and includes a preamble and error-packet information. Furthermore, the error-packet information includes, for example, an error-packet number.

The feedback packet is received by the base station 100, and the base station 100 confirms the packet in which the error is generated from the error-packet information. In addition, the base station 100 can retransmit the corresponding data packet.

The length of the feedback packet varies depending on the configuration method of the RR channel. In addition, the length of the feedback packet is determined so as to include the error information of all data packets that are capable of being received within the period where the terminal 200 transmits the feedback packet through the RR channel.

Meanwhile, when the collision of feedback packets is generated in the RR channel, thereby not allowing confirmation of the error-packet information, the base station 100 retransmits all data packets transmitted within the transmission period of the feedback packet.

The method of allocating the RR channel can utilize all of the methods illustrated in FIG. 4 and FIG. 5.

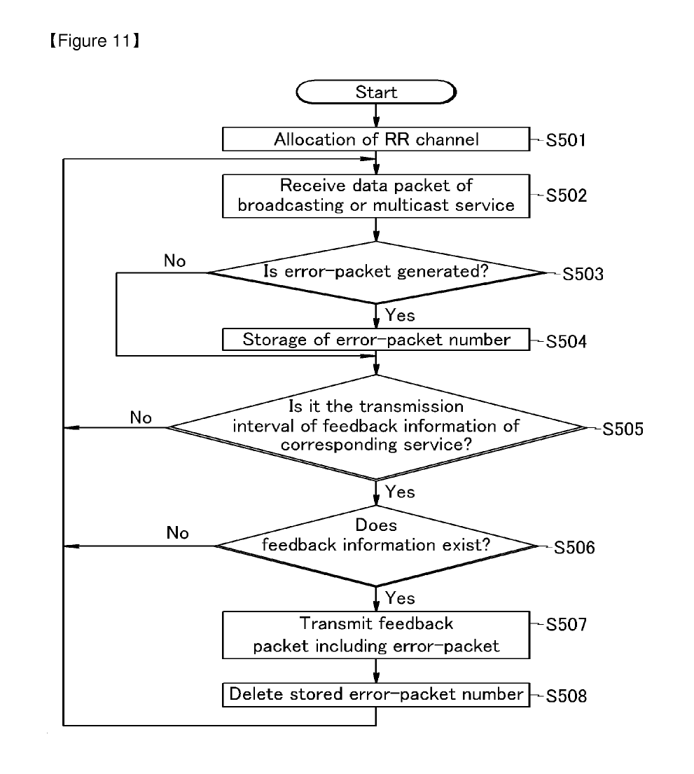

FIG. 11 is a flowchart illustrating a method of requesting a packet retransmission by the terminal 200 according to the second exemplary embodiment of the invention.

Referring to FIG. 11, the terminal 200 allocates the RR channel so as to transmit the feedback packet depending on the data packet reception of the broadcasting or multicast service (S501).

Then, the terminal 200 receives the data packet of the broadcasting or multicast service from the base station 100 (S502) and checks whether the error-packet exists in the received data packets.

When the error-packet is generated (S503), the terminal 200 stores an error-packet number (S504). This is to keep the error-packet number depending on the transmission period of the feedback packet until before a transmission interval of feedback information corresponding to the presently receiving service.

When it becomes the transmission interval of feedback information (S505), the terminal 200 confirms whether the feedback information exists. That is, in this case, the terminal 200 confirms whether the stored error-packet number exists (S506). When the stored error-packet number exists, the feedback packet is transmitted to the base station 100 through the RR channel (S507), the feedback packet being of the same type as the packet in FIG. 10. Then, the terminal 200 deletes the transmitted error-packet number (S508).

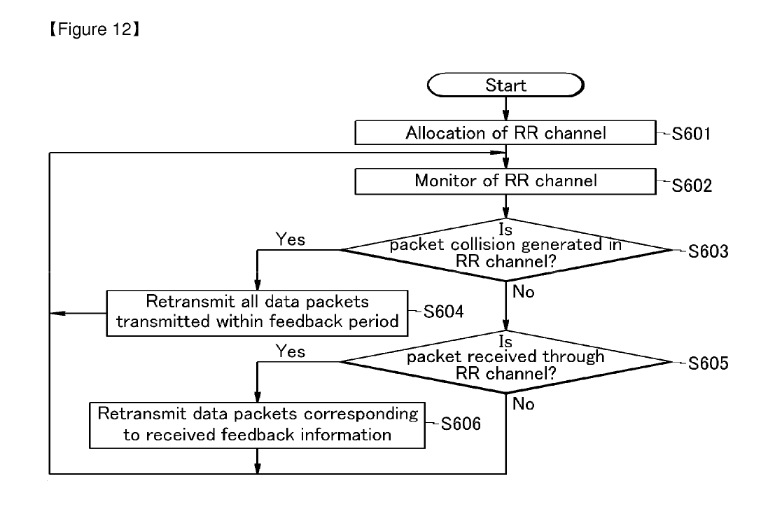

FIG. 12 is a flowchart illustrating a method of retransmitting a packet by the base station 100 according to the second exemplary embodiment of the invention.

Referring to FIG. 12, the base station 100 allocates the RR channel so as to receive the feedback packet to be transmitted from the plurality of terminals 200 depending on the data packet transmission of the broadcasting or multicast service (S601).

Then, the base station 100 monitors the RR channel (S602) to confirm whether the feedback packet is generated, the feedback packet being transmitted through the RR channel from the terminal 200.

When the packet collision is generated in the RR channel (S603), the base station 100 determines that the plurality of terminals 200 transmit the feedback packet. Furthermore, in this case, the base station 100 retransmits the data packet of the service corresponding to the RR channel in which the packet collision is generated. At this time, all of the data packets transmitted within the feedback period corresponding to the present feedback packet collision are retransmitted (S604).

On the other hand, when the feedback packet is received through the RR channel (S605), the base station 100 retransmits only the data packets corresponding to the error-packet information included in the received feedback packet (S606).

As described above, in the method where the plurality of terminals 200 provided with one broadcasting or multicast service share the RR channel so as to transmit the retransmission request for the data packet, the plurality of terminals 200 transmit the retransmission request without separately allocating the channel to each terminal 200. Accordingly, the base station 100 may efficiently acquire the retransmission request at the service, for example the broadcasting or multicast service that simultaneously provides the data packet to many users, thereby retransmitting the data packet.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of changing a transmission mode by a terminal for receiving a data packet of a broadcasting or multicast service, the method comprising:
taking allocation of a random access channel so as to transmit channel information corresponding to the broadcasting or multicast service;
measuring a received signal quality by using a pilot signal included in the data packet;
determining whether a change of transmission mode is necessary based on the received signal quality; and
transmitting channel information for requesting the change of the transmission mode through the random access channel, when the change of the transmission mode is necessary.

2. A method of changing a transmission mode by a terminal for receiving a data packet of a broadcasting or multicast service, the method comprising:
taking allocation of a random access channel so as to transmit channel information corresponding to the broadcasting or multicast service;
receiving a message for changing the transmission mode;
determining whether a change of transmission mode is suitable based on a received signal quality of the data packet; and
transmitting a request for maintaining the transmission mode through the random access channel, when the change of the transmission mode is not suitable.

3. The method of claim 1, wherein the taking allocation includes taking allocation of the random access channel to a time interval corresponding to the broadcasting or multicast service among one or more time intervals that are separately divided into one or more broadcasting or multicast services.

4. (canceled)

5. (canceled)

6. The method of claim 1, wherein the taking allocation includes taking allocation of the random access channel corresponding to the broadcasting or multicast service among random access channels that are separately allocated to one or more broadcasting or multicast services.

7. (canceled)

8. The method of claim 1, wherein the taking allocation includes taking allocation of the random access channel corresponding to the broadcasting or multicast service among a plurality of random access channels of which a plurality of channels is divided into a plurality of time intervals so as to correspond to one or more broadcasting or multicast services.

9. (canceled)

10. (canceled)

11. The method of claim 2, wherein:
the message for changing the transmission mode corresponds to an upward adjustment of transmission speed; and
the determining includes determining that the change of the transmission mode is feasible when the upward adjustment of transmission speed is suitable for the received signal quality.

12. The method of claim 1, wherein
the transmitting includes selecting a transmission mode that is suitable for the received signal quality, and
transmitting a preamble and the channel information through the random access channel by using a channel information packet including the transmission mode.

13. The method of claim 2, wherein the transmitting includes transmitting the request for maintaining the transmission mode through the random access channel by using a channel information packet including the preamble and response information for maintaining the transmission mode.

14. A method of changing a transmission mode by a base station for providing a broadcasting or multicast service, the method comprising:
allocating a channel to at least one terminal so as to receive a channel information packet corresponding to the broadcasting or multicast service;
confirming whether a packet is transmitted through the channel from the at least one terminal; and
changing a transmission mode corresponding to the broadcasting or multicast service, when the packet is transmitted through the channel.

15. The method of claim 14, wherein
the allocating includes dividing one random access channel into a plurality of time intervals based on the number of a plurality of broadcasting or multicast services including the broadcasting or multicast service, and
allocating the channel corresponding to one time interval of the plurality of time intervals to the at least one terminal.

16. The method of claim 14, wherein
the allocating includes selecting a plurality of random access channels based on the number of the plurality of broadcasting or multicast services including the broadcasting or multicast service, and
selecting one of the plurality of random access channels as the channel.

17. (canceled)

18. The method of claim 15, wherein:
the confirming includes confirming whether a packet collision is generated in the channel, and
confirming whether a channel information packet is received through the channel; and
the changing includes adjusting the transmission mode downwardly by one level, when the packet collision is generated, or
adjusting the transmission mode downwardly based on the received channel information packet, when the channel information packet is received.

19. A method of changing a transmission mode by a base station for providing a broadcasting or multicast service, the method comprising:
requesting a change of a transmission mode, when a request for changing the transmission mode is not transmitted from at least one terminal provided with the broadcasting and multicast service during a predetermined time;
maintaining a transmission mode corresponding to the broadcasting or multicast service, when a response is transmitted from the at least one terminal depending on the request for changing the transmission mode; and
changing the transmission mode, when the number of requests for changing the transmission mode is not less than a predetermined number.

20. The method of claim 19, wherein
the requesting includes allocating a channel receiving the request for changing the transmission mode to the at least one terminal, and
determining that the request for changing the transmission mode is transmitted from the at least one terminal, when a packet collision is generated in the channel or when a packet is received through the channel.

21. The method of claim 19, wherein
the maintaining includes allocating a channel for transmitting the response, and
determining that the response is transmitted from the at least one terminal, when a packet collision is generated in the channel or when a packet is received through the channel.

22. (canceled)

23. (canceled)

24. (canceled)

25. (canceled)

26. (canceled)

27. A method of requesting a packet retransmission by a terminal provided with a broadcasting or multicast service, the method comprising:
taking allocation of a random access channel so as to transmit a request for packet retransmission;
confirming whether an error-packet exists in data packets received depending on the broadcasting or multicast service; and
transmitting the request for the packet retransmission by using the random access channel, when the error-packet exists.

28. The method of claim 27, further comprising:
storing an error-packet number; and
deleting the error-packet number, when the request for the packet retransmission is transmitted.

29. The method of claim 28, wherein the transmitting includes transmitting the request for the packet retransmission including the error-packet number, when a transmission interval of feedback information corresponds to the broadcasting or multicast service.

30. A method of retransmitting a packet by a base station provided with a broadcasting or multicast service, the method comprising:
allocating a channel so as to receive a request for retransmitting the packet;
retransmitting a packet corresponding to the request for retransmitting the packet, when the request for retransmitting the packet is received through the channel; and
retransmitting all packets transmitted during a present feedback interval of the broadcasting or multicast service, when a packet collision is generated in the channel.

31. The method of claim 30, wherein
the retransmitting the packet corresponding to the request for retransmitting the packet includes extracting an error-packet number included in the packet retransmission request, and
retransmitting the packet corresponding to the error-packet number.
